(19) United States
(12) Patent Application Publication
(10) Pub. No.: US 2024/0313491 A1
(43) Pub. Date: Sep. 19, 2024

(54) ELECTRIC WIRE ACCOMMODATION DEVICE AND ELECTRIC WIRE PROCESSING APPARATUS

(71) Applicant: Yazaki Corporation, Tokyo (JP)

(72) Inventors: Takuya NAKADA, Makinohara-shi (JP); Yuta SUGANUMA, Makinohara-shi (JP); Akihiro MIZUNO, Makinohara-shi (JP)

(73) Assignee: Yazaki Corporation, Tokyo (JP)

(21) Appl. No.: 18/670,835

(22) Filed: May 22, 2024

Related U.S. Application Data
(63) Continuation of application No. PCT/JP2022/045286, filed on Dec. 8, 2022.

(30) Foreign Application Priority Data
Dec. 27, 2021 (JP) 2021-212942

(51) Int. Cl. H01R 43/052

(52) U.S. Cl. CPC H01R 43/052

(57) ABSTRACT

An electric wire accommodation device includes an accommodation device body, an electric wire reel being a reel around which an electric wire is wound and configured to be accommodated inside the accommodation device body, in which the electric wire is configured to be pulled out to outside of the accommodation device body and to be intermittently reeled out by a reel-out mechanism provided outside the accommodation device body, and an electric wire gripping member attached on a pull-out route in the accommodation device body along which the electric wire is pulled out and configured to grip the electric wire with a gripping force smaller than a reel-out force applied by the reel-out mechanism.

The present invention relates to an electric wire accommodation device in which an electric wire reel is accommodated in an accommodation device body and an electric wire is pulled out to outside of the accommodation device body for use, and an electric wire processing apparatus including the electric wire accommodation device. The present application is a continuation application of International Application No. PCT/JP2022/045286, filed on Dec. 8, 2022, whose priority is claimed on Japanese Patent Application No. 2021-212942, filed on Dec. 27, 2021. All of the contents of the International Application and the Japanese Patent Application are incorporated herein with reference.

### TECHNICAL FIELD

### Background Art

In the related art, there has been known an electric wire accommodation device which is provided in an electric wire processing apparatus for cutting a segment electric wire or manufacturing a terminal-equipped electric wire and which accommodates an electric wire to be processed (for example, see Patent Literature 1). In the electric wire accommodation device described in Patent Literature 1, an electric wire reel is accommodated in a state of being placed on a horizontally bridged shelf plate. Further, the electric wire is pulled out from the electric wire reel to the outside of the accommodation device body, and is bridged to a body mechanism that performs cutting of a segment electric wire out of the electric wire, crimping of a terminal, and the like in the electric wire processing apparatus.

### CITATION LIST

### Patent Literature

Patent Literature 1: Japanese Patent No. 6209475

### SUMMARY OF INVENTION

### Technical Problem

Here, in the body mechanism of the above electric wire processing apparatus, the electric wire pulled out from the electric wire accommodation device is intermittently reeled out by a reel-out mechanism and is cut to manufacture the segment electric wires. In recent years, in the field of electric wire processing apparatuses, an operation speed of the apparatus is significantly increased in order to shorten the manufacturing time, and at the time of intermittent reeling out, reeling out of the electric wire at a high speed and sudden stop of reeling out are repeated. At this time, at a side of the electric wire accommodation device, when a reel-out speed by the reel-out mechanism is fast, even when the reeling out is suddenly stopped, a movement cannot be followed, and the electric wire may be pulled out from the electric wire accommodation device by inertia even after the reeling out is stopped. When such pulling out by inertia is repeated many times, slack occurs in the electric wire bridged from the electric wire accommodation device to the body mechanism. When such slack of the electric wire increases, it may cause entanglement of the electric wire or the like, which is not desirable.

Here, in order to discuss the problem of slack of the electric wire when the electric wire is intermittently reeled out at a high speed, the electric wire accommodation device of the electric wire processing apparatus that performs cutting of the segment electric wire and manufacturing of the terminal-equipped electric wire has been described just as an example. Such a problem is not limited to electric wire processing as described above, but may occur in common as long as it is an electric wire accommodation device in which an electric wire reel is accommodated, and an electric wire is pulled out to outside of the electric wire accommodation device and is intermittently reeled out by a reel-out mechanism.

Therefore, the present invention focuses on the above problem, and an object thereof is to provide an electric wire accommodation device capable of preventing slack of an electric wire outside the electric wire accommodation device even when the electric wire is intermittently reeled out at a high speed, and an electric wire processing apparatus including such an electric wire accommodation device.

### Solution to Problem

In order to solve the above problem, an electric wire accommodation device includes an accommodation device body, an electric wire reel being a reel around which an electric wire is wound and configured to be accommodated inside the accommodation device body, in which the electric wire is configured to be pulled out to outside of the accommodation device body and to be intermittently reeled out by a reel-out mechanism provided outside the accommodation device body, and an electric wire gripping member attached on a pull-out route in the accommodation device body along which the electric wire is pulled out and configured to grip the electric wire with a gripping force smaller than a reel-out force applied by the reel-out mechanism.

### Advantageous Effects of Invention

According to the electric wire accommodation device and the electric wire processing apparatus described above, slack of the electric wire outside the electric wire accommodation device can be prevented even when the electric wire is intermittently reeled out at a high speed.

### BRIEF DESCRIPTION OF DRAWINGS

FIG. 1 is an appearance diagram showing an embodiment of an electric wire processing apparatus;

FIG. 2 is a schematic view showing a main part of the electric wire processing apparatus shown in FIG. 1 in which terminal crimping is performed;

FIG. 3 is a schematic view showing an example of a terminal-equipped electric wire manufactured in the electric wire processing apparatus shown in FIGS. 1 and 2;

FIG. 4 is a plan view of a portion of a left end of the electric wire accommodation device shown in FIG. 1, as viewed from a V11 direction in FIG. 1;

FIG. 5 is a cross-sectional view showing a partial cross-section of the electric wire accommodation device shown in FIG. 4 taken along line V12-V12 in FIG. 4;

FIG. 6 is a perspective view of an electric wire gripping member shown in FIGS. 1, 4, and 5 as viewed from a side from which an electric wire is pulled out; and

FIG. 7 is a cross-sectional view showing a cross section of the electric wire gripping member shown in FIG. 6 taken along line V13-V13 in FIG. 6.

### DESCRIPTION OF EMBODIMENTS

Hereinafter, an embodiment of an electric wire accommodation device and an electric wire processing apparatus will be described.

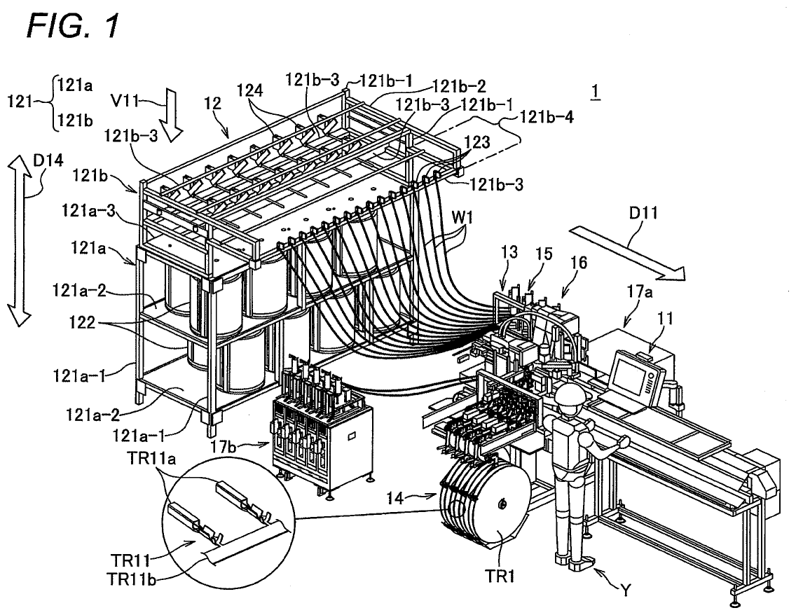

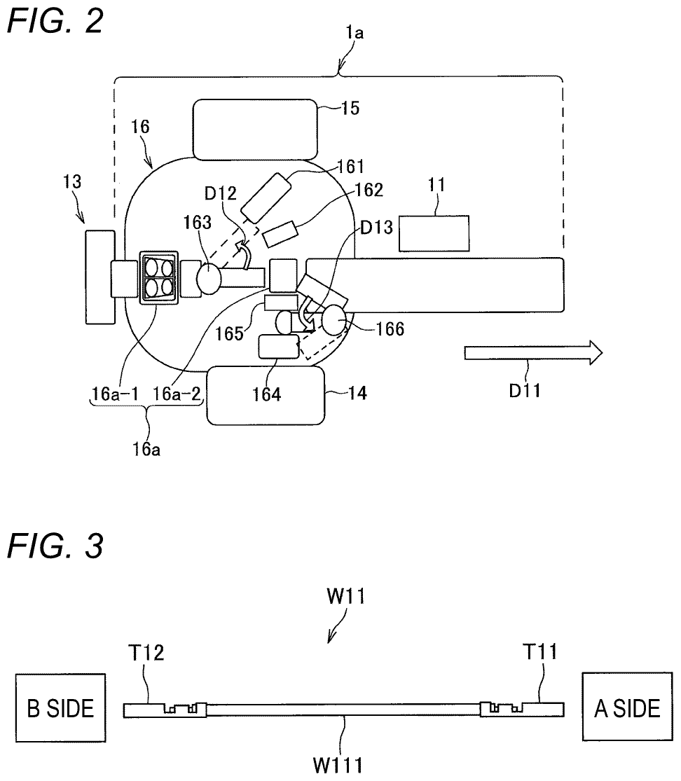

FIG. 1 is an appearance diagram showing the embodiment of the electric wire processing apparatus, and FIG. 2 is a schematic view showing a main part of the electric wire processing apparatus shown in FIG. 1 in which terminal crimping is performed. In addition, FIG. 3 is a schematic view showing an example of a terminal-equipped electric wire manufactured by the electric wire processing apparatus shown in FIGS. 1 and 2.

An electric wire processing apparatus 1 shown in FIGS. 1 and 2 is an apparatus for manufacturing a terminal-equipped electric wire W11 of which an example is shown in FIG. 3, for example. FIG. 3 shows the terminal-equipped electric wire W11 in which terminals are crimped to both ends of a segment electric wire W111.

Here, in order to manufacture the terminal-equipped electric wire W11 shown in FIG. 3 using the electric wire processing apparatus 1, an electric wire W1, which is to be supplied in a manner to be described later, is reeled out in a reel-out direction D11 indicated by an arrow in FIG. 2, and the segment electric wire W111 is cut out. At this time, a front side in the reel-out direction D11 is referred to as an A side and a rear side is referred to as a B side, a terminal crimped to the A side of the segment electric wire W111 is referred to as an A-side terminal T11, and a terminal crimped to the B side is referred to as a B-side terminal T12. The terminal-equipped electric wire is not limited to the form shown in FIG. 3, and may be any electric wire in which a terminal is crimped only to one end of the segment electric wire as long as a terminal is crimped to at least one end of the segment electric wire. Further, in the electric wire processing apparatus 1, it is also possible to perform only the cutting of the segment electric wire W111 including peeling of an end portion without performing terminal crimping. Hereinafter, the electric wire processing apparatus 1 shown in FIGS. 1 and 2 will be described as a device for manufacturing the terminal-equipped electric wire W11 in which the terminals T11 and T12 are crimped to both ends based on the example of FIG. 3.

The electric wire processing apparatus 1 includes an information acquisition unit 11, an electric wire accommodation device 12, an electric wire supply device 13, a B-side terminal supply portion 14, an A-side terminal supply portion 15, a body mechanism 16, an A-side rubber plug supply portion 17a, and a B-side rubber plug supply portion 17b.

In order to manufacture the terminal-equipped electric wire W11, the information acquisition unit 11 acquires manufacturing information including an electric wire type of the segment electric wire W111 and a terminal type of the terminal. Specifically, the information acquisition unit 11 receives an input made by an operator Y and acquires, as the manufacturing information, product number data associated with the electric wire type and the terminal type.

In the electric wire accommodation device 12, a plurality of electric wire reels 122 having different electric wire types from each other are accommodated in an accommodation device body 121. The electric wires wound around the plurality of electric wire reels 122 are all covered electric wires and have different thicknesses, colors, and the like. Further, the electric wire W1 pulled out from some of the electric wire reels 122 selected out of the plurality of electric wire reels 122 is extended to the electric wire supply device 13 as a candidate for cutting out the segment electric wire W111 therefrom. In the present embodiment, as an example, a configuration in which the electric wires W1 are pulled out from all of the plurality of electric wire reels 122 is shown. The electric wire accommodation device 12 will be described in detail later.

The electric wire supply device 13 is a device configured to, with an electric wire to be supplied for use having been designated from the plurality of types of electric wires W1 in the electric wire accommodation device 12, supply the electric wire to be used to a supply position for cutting the segment electric wire W111 or crimping a terminal.

Each of the B-side terminal supply portion 14 and the A-side terminal supply portion 15 holds a plurality of types of terminal reels TR1 having different terminal types from each other and on which a chained-terminals body TR11 in which a plurality of terminals TR11a are connected via a strip-shaped carrier TR11b is wound. The B-side terminal supply portion 14 holds the plurality of types of terminal reels TR1 as candidates for the B-side terminal T12, and the A-side terminal supply portion 15 holds the plurality of types of terminal reels TR1 as candidates for the A-side terminal T11. Further, the B-side terminal supply portion 14 and the A-side terminal supply portion 15 supply, with terminal reels to be used having been selected from the plurality of types of terminal reels TR1 for the B-side and the A-side respectively, the terminal reels to be used.

The body mechanism 16 cuts out the segment electric wire W111 from the electric wire to be used supplied from the electric wire supply device 13, and crimps terminals of the supplied terminal reels to end portions of the B side and the A side of the segment electric wire W111, respectively, to manufacture the terminal-equipped electric wire W11. The body mechanism 16 includes a cut-out portion 16a that cuts out the segment electric wire W111 by performing reeling out on the electric wire to be used in the reel-out direction D11 and performing cutting. The cut-out portion 16a includes a reel-out mechanism 16a-1 that intermittently performs reeling out with a reel-out length corresponding to a length of the segment electric wire W111, and a cutting mechanism 16a-2 that performs cutting. In addition, the cutting mechanism 16a-2 is a mechanism capable of peeling coating on the end portions of the cut electric wire.

Further, the body mechanism 16 includes an A-side crimping machine 161, an A-side rubber plug inserting machine 162, and an A-side electric wire moving arm 163 as mechanism portions for terminal crimping on the A side. Here, the terminal crimping on the A side refers to terminal crimping to a front end of the electric wire to be used in the reel-out direction D11. The A-side crimping machine 161 crimps, as the A-side terminal T11, the terminal of the used terminal reel supplied by the A-side terminal supply portion 15 to the front end of the electric wire to be used in the reel-out direction D11. When an A-side rubber plug is supplied from the A-side rubber plug supply portion 17a as described later, the A-side rubber plug inserting machine 162 inserts the A-side rubber plug into the front end of the electric wire to be used in the reel-out direction D11 before the terminal crimping by the A-side crimping machine 161. In this case, the terminal crimping by the A-side crimping machine 161 is performed from above the inserted rubber plug. The A-side electric wire moving arm 163 is an A-side arm mechanism that grips the electric wire reeled-out by the cut-out portion 16a, moves the front end of the electric wire in the reel-out direction D11 toward a direction of an arrow D12, and positions the electric wire to be used with respect to the A-side crimping machine 161 and the A-side rubber plug inserting machine 162.

In addition, the body mechanism 16 includes a B-side crimping machine 164, a B-side rubber plug inserting machine 165, and a B-side electric wire moving arm 166 as mechanism portions for terminal crimping on the B side. Here, the terminal crimping on the B side refers to terminal crimping on a rear end, in the reel-out direction D11, of the terminal-equipped segment electric wire that is cut out after the terminal crimping by the A-side crimping machine 161 is performed. The B-side crimping machine 164 crimps, as the B-side terminal T12, the terminal of the used terminal reel supplied by the B-side terminal supply portion 14 to the rear end of the terminal-equipped segment electric wire in the reel-out direction D11. When a B-side rubber plug is supplied from the B-side rubber plug supply portion 17b as described later, the B-side rubber plug inserting machine 165 inserts the B-side rubber plug into the rear end of the terminal-equipped segment electric wire in the reel-out direction D11 before the terminal crimping by the B-side crimping machine 164. In this case, the terminal crimping by the B-side crimping machine 164 is performed from above the inserted rubber plug. The B-side electric wire moving arm 166 is a B-side arm mechanism that grips the terminal-equipped segment electric wire cut out by the cut-out portion 16a, moves the rear end of the terminal-equipped segment electric wire in the reel-out direction D11 toward a direction of an arrow D13, and positions the terminal-equipped segment electric wire with respect to the B-side crimping machine 164 and the B-side rubber plug inserting machine 165.

The A-side rubber plug supply portion 17a and the B-side rubber plug supply portion 17b are devices that hold a plurality of types of rubber plugs and supply the rubber plugs to the A-side rubber plug inserting machine 162 and the B-side rubber plug inserting machine 165, respectively. In the present embodiment, although not shown, the terminal-equipped electric wire W11 can be manufactured by any type of a rubber plug insertion type in which terminal crimping is performed from above the rubber plug and a rubber plug non-insertion type in which terminal crimping is directly performed on the end portions of the segment electric wire. Further, as a processing type, it is also possible to manufacture the electric wire merely by cutting out the segment electric wire W111 and peeling the end portion without performing any of the terminal crimping and the rubber plug insertion. As the manufacturing information, that is, the product number data, in addition to the electric wire type and the terminal type, any processing type among the rubber plug insertion type, the rubber plug non-insertion type, and the electric wire cutting, as well as the rubber plug type in the case where the rubber plug insertion type is selected are all included. In the case where the rubber plug insertion type is selected, the A-side rubber plug supply portion 17a and the B-side rubber plug supply portion 17b supply the rubber plug of the designated rubber plug type to the A-side rubber plug inserting machine 162 and the B-side rubber plug inserting machine 165, respectively, based on the product number data.

In the electric wire processing apparatus 1 schematically described above, before the processing of the electric wire, the operator Y inputs the product number data to the information acquisition unit 11. Thereafter, when a start button is pressed, the electric wire supply based on the product number data is performed by the electric wire supply device 13, and the supply of the terminal reels to be used on the A side and the B side and the supply of the rubber plugs on the A side and the B side in the case where the rubber plug insertion type is selected are performed. Further, in the body mechanism 16, the supplied electric wire, the terminals of the terminal reels, and the rubber plugs are used to cut out the electric wire and manufacture the terminal-equipped electric wire W11. The manufactured terminal-equipped electric wire W11 is discharged to a predetermined accommodation place. In addition, the manufacturing number of the terminal-equipped electric wire W11 is also associated with the product number data, and the above manufacturing of the terminal-equipped electric wire W11 is repeatedly executed until the designated manufacturing number is achieved.

Next, the above electric wire accommodation device 12 will be described in detail with reference to FIG. 1 and other drawings.

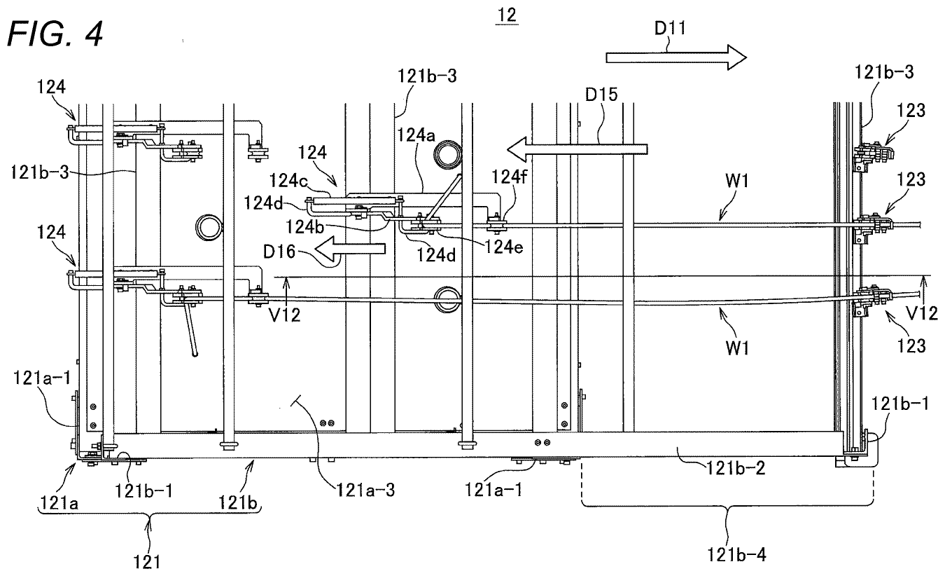

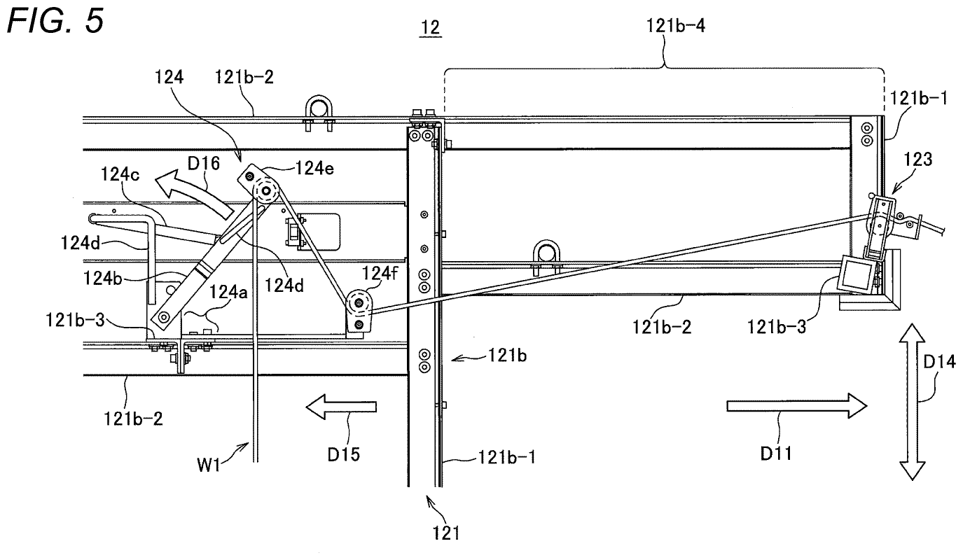

FIG. 4 is a plan view of a portion of a left end of the electric wire accommodation device shown in FIG. 1, as viewed from a V11 direction in FIG. 1, and FIG. 5 is a cross-sectional view showing a partial cross-section of the electric wire accommodation device shown in FIG. 4 taken along line V12-V12 in FIG. 4.

The electric wire accommodation device 12 includes the accommodation device body 121, the plurality of electric wire reels 122, a plurality of electric wire gripping members 123, and a plurality of drawing mechanisms 124.

The accommodation device body 121 includes an accommodation shelf 121a and a guide support portion 121b. The accommodation shelf 121a is a structure in which two shelf plates 121a-2 and one top plate 121a-3 are horizontally bridged between a plurality of column members 121a-1 each of which is provided upright along a vertical direction D14. The guide support portion 121b is a frame structure constructed on the top plate 121a-3 by combining a plurality of column members 121b-1, a plurality of vertical rails 121b-2, and a plurality of horizontal rails 121b-3. The guide support portion 121b supports the electric wire gripping members 123 and the drawing mechanisms 124, and guides the electric wires W1 of the electric wire reels 122 via the members. A part of the guide support portion 121b is an overhang portion 121b-4 that overhangs, at a position above the accommodation shelf 121a, toward the body mechanism 16 including the above reel-out mechanism 16a-1.

The plurality of electric wire reels 122 are reels around which the electric wires W1 are wound, and are accommodated in the accommodation device body 121. As described above, the electric wire types of the plurality of electric wire reels 122 are different from each other. Each electric wire reel 122 is placed on the two shelf plates 121a-2 such that a reel axis is along the vertical direction D14. In addition, the electric wire W1 of each electric wire reel 122 is pulled out upward from the electric wire reel 122, passes through the top plate 121a-3, and is pulled out to outside of the accommodation device body 121 via the respective drawing mechanism 124 and the respective electric wire gripping member 123 in this order. When being designated as the electric wire to be used based on the above product number data, the pulled-out electric wire W1 is supplied to the reel-out mechanism 16a-1 of the body mechanism 16 by the electric wire supply device 13, and is intermittently reeled out by the reel-out mechanism 16a-1.

Next, the drawing mechanism 124 by which the electric wire W1 of the electric wire reel 122 is suspended in front of the electric wire gripping member 123 will be described.

The plurality of drawing mechanisms 124 are provided such that each of the plurality of drawing mechanisms 124 corresponds with respective one of the plurality of electric wire reels 122. Each drawing mechanism 124 is attached at a position closer to the respective electric wire reel 122 than the respective electric wire gripping member 123 on a pull-out route of the respective electric wire W1 in the guide support portion 121b of the accommodation device body 121. Specifically, as shown in FIG. 1, the plurality of drawing mechanisms 124 are attached to each of the two horizontal rails 121b-3 on a back side of the guide support portion 121b. The electric wire W1 pulled out upward from the respective electric wire reel 122 and passing through the top plate 121a-3 is suspended on the respective drawing mechanism 124. Then, the respective drawing mechanism 124 pulls upward the electric wire W1, draws in a drawing direction D15 opposite to the reel-out direction D11 by the reel-out mechanism 16a-1 and lets the electric wire W1 pass through the electric wire gripping member 123.

Each drawing mechanism 124 includes a base portion 124a, a pivot arm 124b, a drawing biasing member 124c, a pair of spring coupling portions 124d, a rotatable pulley 124e, and a fixed pulley 124f. The base portion 124a is a strip-shaped portion fixed to the horizontal rail 121b-3, and upright plate portions in the vertical direction D14 are provided at both ends of the base portion 124a. The pivot arm 124b is an arm member pivotably supported at the upright plate portion on one end side of the base portion 124a. The drawing biasing member 124c is a spring member, one end of which is coupled to the upright plate portion of the base portion 124a and the other end of which is coupled to an intermediate position of the pivot arm 124b, and which draws the pivot arm 124b by biasing the pivot arm 124b in a biasing direction D16 in which a tip of the pivot arm 124b is pulled up. The pair of spring coupling portions 124d are members in which one end of the drawing biasing member 124c is coupled to the upright plate portion of the base portion 124a by one of the pair of spring coupling portions 124d, and one end of the drawing biasing member 124c is coupled to the intermediate position of the pivot arm 124b by the other of the pair of spring coupling portions 124d. The rotatable pulley 124e is a pulley that is attached to the tip of the pivot arm 124b and suspends and supports the electric wire W1 passing through the top plate 121a-3. The fixed pulley 124f is a pulley that is attached to the upright plate portion of the base portion 124a on a side opposite to the pivot arm 124b and suspends and supports the electric wire W1 via the rotatable pulley 124e. The drawing mechanism 124 draws the electric wire W1 suspended and supported by the rotatable pulley 124e and the fixed pulley 124f in the drawing direction D15 by the biasing of the pivot arm 124b by the drawing biasing member 124c.

Next, the electric wire gripping member 123 that grips the electric wire W1 suspended and supported while being drawn by the drawing mechanism 124 before being pulled out from the accommodation device body 121 will be described.

The plurality of electric wire gripping members 123 are provided each of the plurality of electric wire gripping members 123 corresponds with respective one of the plurality of electric wire reels 122, similarly to the above drawing mechanisms 124. Each electric wire gripping member 123 is attached at a position farther from the respective electric wire reel 122 than the respective drawing mechanism 124 on the pull-out route of the respective electric wire W1 in the guide support portion 121b of the accommodation device body 121. Specifically, as shown in FIG. 1, the plurality of electric wire gripping members 123 are attached to one horizontal rail 121b-3 corresponding to an edge portion of the overhang portion 121b-4 of the guide support portion 121b on a side of the reel-out mechanism 16a-1.

After being pulled out upward from the electric wire reel 122, the direction of the electric wire W1 is changed to a horizontal side by the drawing mechanism 124, and the electric wire W1 extends horizontally and is pulled out to the outside of the accommodation device body 121. The electric wire gripping member 123 grips a horizontally extending portion of the electric wire W1 after passing through the drawing mechanism 124 with a gripping force weaker than a reel-out force of the reel-out mechanism 16a-1.

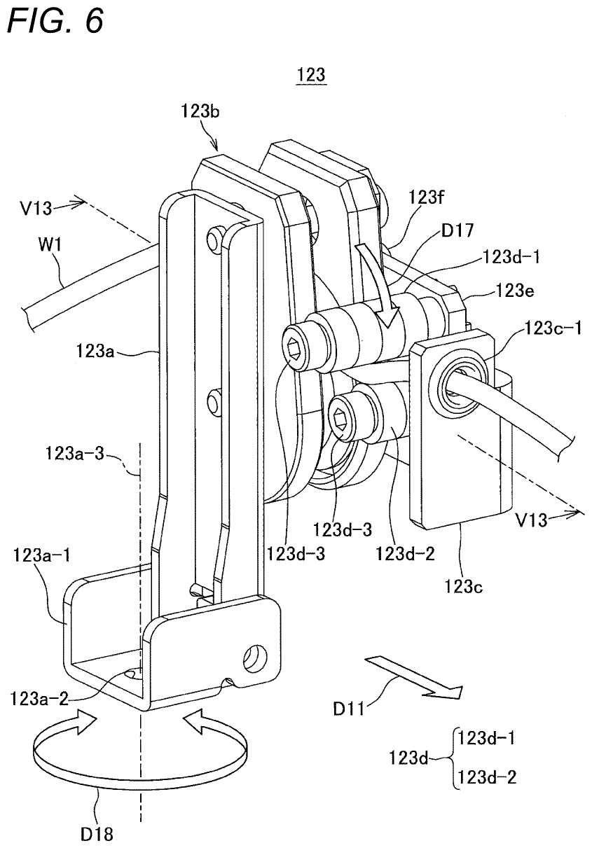

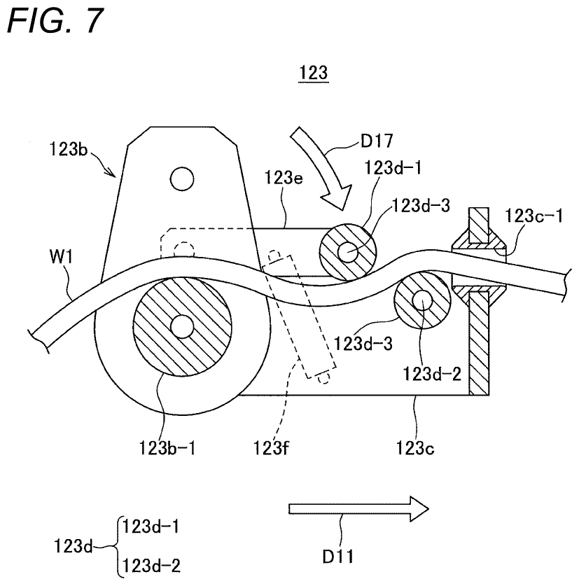

FIG. 6 is a perspective view of the electric wire gripping member shown in FIGS. 1, 4, and 5 as viewed from a side from which an electric wire is pulled out, and FIG. 7 is a cross-sectional view showing a cross section of the electric wire gripping member shown in FIG. 6 taken along line V13-V13 in FIG. 6.

Each electric wire gripping member 123 includes an attachment base portion 123a, a pre-gripping pulley 123b, a plate portion 123c, a pair of rollers 123d, a gripping arm 123e, and a gripping biasing member 123f.

The attachment base portion 123a is a columnar member that is upright fixed to the horizontal rail 121b-3 of the guide support portion 121b, and supports other components of the electric wire gripping member 123. The pre-gripping pulley 123b is a member that is fixed to a side surface of the attachment base portion 123a and passes the electric wire W1 in the reel-out direction D11 while receiving the electric wire W1 at an upper portion of an inner rotation portion 123b-1. The plate portion 123c is a plate member that is fixed to a side surface of the pre-gripping pulley 123b opposite to the attachment base portion 123a, extends from the side surface in the reel-out direction D11, and is bent at a front end portion thereof so as to intersect with the reel-out direction D11 to be formed in an L shape. A delivery port 123c-1 for delivering the electric wire W1 in the reel-out direction D11 is provided in a wall portion of the plate portion 123c intersecting with the reel-out direction D11. The pair of rollers 123d are members that are disposed between the pre-gripping pulley 123b and the delivery port 123c-1 for the electric wire W1, sandwich the electric wire W1 passing through the rollers between peripheral surfaces thereof, and are rotatable around shafts 123d-3, respectively. Of the pair of rollers 123d, a first roller 123d-1 is supported by a tip of the gripping arm 123e, and a second roller 123d-2 is supported by a side surface of the plate portion 123c. The gripping arm 123e is an arm member whose end portion opposite to the first roller 123d-1 is pivotably supported by the pre-gripping pulley 123b. In addition, the gripping biasing member 123f is a biasing spring including one end fixed to the gripping arm 123e and the other end fixed to the plate portion 123c, and biasing the first roller 123d-1 in a biasing direction D17 toward the second roller 123d-2 via the gripping arm 123e. As described above, a biasing force by the gripping biasing member 123f is a biasing force corresponding to the gripping force for gripping the electric wire W1 that is weaker than the reel-out force by the reel-out mechanism 16a-1.

In addition, in the present embodiment, the attachment base portion 123a is fixed to the horizontal rail 121b-3 of the guide support portion 121b such that an attachment posture can be adjusted such that the delivery port 123c-1 in the plate portion 123c is opened toward the reel-out mechanism 16a-1 through the electric wire supply device 13. Specifically, a pedestal portion 123a-1 for screwing and fixing is provided on a lower end side of the attachment base portion 123a, and the attachment base portion 123a is screwed and fixed to the horizontal rail 121b-3 via a screwing through hole 123a-2 of the pedestal portion 123a-1. By loosening a fixing screw (not shown), it is possible to adjust a direction of the delivery port 123c-1 with respect to an adjustment rotation direction D18 around a central axis 123a-3 of the screw fixing through hole 123a-2.

According to the electric wire accommodation device 12 and the electric wire processing apparatus 1 according to the above embodiment, the electric wire W1 pulled out from the electric wire reel 122 is reeled out by the reel-out mechanism 16a-1 in a state of being always gripped by the electric wire gripping member 123. Since the gripping force by the electric wire gripping member 123 is weaker than the reel-out force by the reel-out mechanism 16a-1, no trouble occurs in the reeling out of the electric wire W1. On the other hand, when the reeling out is stopped and the reel-out force disappears, the gripping force by the electric wire gripping member 123 plays a role of restricting the movement of the electric wire W1 which is movement by inertia. As a result of such restriction, the pulling out of the electric wire W1 due to inertia after stopping the reeling out is prevented, and the slack of the electric wire W1 outside the electric wire accommodation device 12 is prevented. That is, according to the above electric wire accommodation device 12, slack of the electric wire W1 outside the electric wire accommodation device 12 can be prevented even when the electric wire W1 is intermittently reeled out at a high speed.

Here, in the present embodiment, the electric wire gripping member 123 is configured such that the electric wire W1 is sandwiched between the circumferential surfaces of the pair of rollers 123d biased by the gripping biasing member 123f. According to this configuration, since the electric wire W1 is sandwiched between the circumferential surfaces of the pair of rollers 123d that are rotatable, it is possible to effectively grip the electric wire W1 while preventing friction or the like when being reeled out at a high speed.

In addition, in the present embodiment, the electric wire gripping member 123 is attached to the accommodation device body 121 such that the attachment posture can be adjusted such that the delivery port 123c-1 of the electric wire W1 is opened toward the reel-out mechanism 16a-1. According to this configuration, it is possible to appropriately deliver the gripped electric wire W1 toward the reel-out mechanism 16a-1 by adjusting the attachment posture of the electric wire gripping member 123.

In addition, in the present embodiment, the drawing mechanism 124 that draws the electric wire W1 at a position closer to the electric wire reel 122 than the electric wire gripping member 123 and allows the electric wire W1 to pass through is provided. According to this configuration, since the electric wire W1 is drawn by the drawing mechanism 124 in the drawing direction D15 opposite to the reel-out direction D11 in addition to being gripped by the electric wire gripping member 123, it is possible to further prevent the slack of the electric wire W1 outside the electric wire accommodation device 12.

In addition, in the present embodiment, the accommodation device body 121 is an accommodation shelf, the electric wire reel 122 is placed on the shelf plate 121a-2, and the electric wire gripping member 123 is configured to grip a horizontally extending portion of the electric wire W1. According to this configuration, since the accommodation device body 121 is a simple structure suitable for accommodation such as an accommodation shelf, the cost can be reduced. Further, a portion of the electric wire W1 that extends horizontally toward the outside reel-out mechanism 16a-1 is gripped by the electric wire gripping member 123, the electric wire W1 being pulled out upward, then changing a direction thereof to a horizontal side, and thus extending horizontally. By gripping at such a position, the electric wire gripping member 123 receives an inertial force generated in the electric wire W1 when the reeling out at a high speed is suddenly stopped at a horizontal portion where a direction of the inertial force and the extending direction of the electric wire W1 are closest to each other. Therefore, the slack of the electric wire W1 can be effectively prevented.

In addition, in the present embodiment, the accommodation device body 121 is provided with the overhang portion 121b-4, and the electric wire gripping member 123 is attached to a portion where the electric wire W1 and the horizontal rail 121b-3 corresponding to the edge portion of the overhang portion 121b-4 on the side of the reel-out mechanism 16a-1 intersect with each other. According to this configuration, since the electric wire W1 is gripped at the edge portion of the overhang portion 121b-4, which is a portion close to the outside of the accommodation device body 121 and is close to the reel-out mechanism 16a-1, and the movement due to inertia is restricted, the slack of the electric wire W1 can be effectively prevented.

In addition, in the present embodiment, the plurality of electric wire reels 122, specifically, a plurality of types of the electric wire reels 122 having different electric wire types from each other are accommodated. Further, the plurality of electric wire gripping members 123 are attached to the accommodation device body 121 such that each the plurality of electric wire gripping members 123 grips the electric wire W1 of respective one of the electric wire reels 122. According to this configuration, since the plurality of types of electric wire reels 122 having different electric wire types from each other are accommodated in the accommodation device body 121 of the electric wire accommodation device 12, it is possible to improve the degree of freedom in manufacturing the terminal-equipped electric wire W1 by the electric wire processing apparatus 1.

The embodiment described above merely shows a representative form of the electric wire accommodation device and the electric wire processing apparatus, and the electric wire accommodation device and the electric wire processing apparatus are not limited to this embodiment. That is, the electric wire accommodation device and the electric wire processing apparatus can be variously modified and implemented without departing from the gist thereof.

For example, in the above embodiment, as an example of the electric wire accommodation device and the electric wire processing apparatus, the electric wire accommodation device 12 and the electric wire processing apparatus 1 from which the electric wire W1 designated as the electric wire to be used based on the product number data is reeled out are exemplified. However, the electric wire accommodation device and the electric wire processing apparatus are not limited thereto, and for example, the electric wire to be used may be directly designated and reeled out, and designation making method does not matter.

In addition, in the above embodiment, as an example of the electric wire accommodation device, the electric wire accommodation device 12 of the electric wire processing apparatus 1 capable of performing both the cutting of the segment electric wire W111 not subjected to the terminal crimping and the manufacturing of the terminal-equipped electric wire W11 is exemplified. However, the electric wire accommodation device is not limited thereto, and as long as it is an accommodation device in which the electric wire of the accommodated electric wire reel is pulled out to the outside of the accommodation device and are intermittently reeled out, it is not necessary to determine how the reeled out electric wire should be processed thereafter. For example, processing of the reeled-out electric wire may be only one of cutting of the segment electric wire and manufacturing of the terminal-equipped electric wire W11, or may be rewinding or correction processing of winding habit without special processing.

In addition, in the above embodiment, as an example of the electric wire gripping member, the electric wire gripping member 123 in which the electric wire W1 is sandwiched between the circumferential surfaces of the pair of rollers 123d biased by the gripping biasing member 123f is exemplified. However, the electric wire gripping member is not limited thereto, and may be, for example, a member that grips the electric wire with a clip other than the roller structure, a member that grips the electric wire by passing the electric wire through a flexible rubber tube including a through hole having a thickness narrower than that of the electric wire, or the like. As described above, by adopting the roller structure, it is possible to effectively grip the electric wire W1 while preventing friction or the like when being reeled out at a high speed.

In addition, in the above embodiment, as an example of the electric wire gripping member, the electric wire gripping member 123 capable of adjusting the direction of the delivery port 123c-1 of the electric wire W1 is exemplified. However, the electric wire gripping member is not limited thereto, and may be fixed in a state in which the direction of the delivery port of the electric wire is uniquely determined. Meanwhile, as described above, since the direction of the delivery port 123c-1 of the electric wire W1 is adjustable, the gripped electric wire W1 can be appropriately delivered toward the reel-out mechanism 16a-1.

In addition, in the above embodiment, as an example of the electric wire accommodation device, the electric wire accommodation device 12 in which the drawing mechanism 124 for the electric wire W1 is provided at a position closer to the electric wire reel 122 than the electric wire gripping member 123 is exemplified. However, the electric wire accommodation device is not limited thereto, and such a drawing mechanism may not be provided. As described above, by providing the drawing mechanism 124, it is possible to further prevent the slack of the electric wire W1 outside the electric wire accommodation device 12.

In addition, in the above embodiment, as an example of the electric wire accommodation device, the electric wire accommodation device 12 in which the accommodation device body 121 is an accommodation shelf and the electric wire W1 extending upward from the electric wire reel 122 on the shelf plate 121a-2 is gripped by the electric wire gripping member 123 at a portion extending horizontally by changing the direction thereof is exemplified. However, the electric wire accommodation device is not limited thereto, and may be, for example, an electric wire accommodation device including an accommodation device body, other than a shelf, in which the electric wire reel is rotatably supported and accommodated and the electric wire is pulled out in a circumferential direction, or the like. In addition, even when the accommodation device body having a shelf structure is provided, a support position of the electric wire by the electric wire gripping member may be a portion of the electric wire extending upward or the like. However, as described above, the cost is reduced by adopting the accommodation device body having the shelf structure, and the slack of the electric wire W1 can be effectively prevented by gripping the electric wire at the horizontally extending portion.

In addition, in the above embodiment, as an example of the electric wire accommodation device, the electric wire accommodation device 12 in which the overhang portion 121b-4 is provided in the accommodation device body 121 and the electric wire gripping member 123 is attached to the portion where the edge portion of the overhang portion 121b-4 and the electric wire W1 intersect with each other is exemplified. However, the electric wire accommodation device is not limited thereto, and the accommodation device body may not be provided with the overhang portion, and even when the overhang portion is provided, the attachment position of the electric wire gripping member can be set to any position. However, as described above, the slack of the electric wire W1 can be effectively prevented by attaching the electric wire gripping member 123 to the portion where the edge portion of the overhang portion 121b-4 and the electric wire W1 intersect with each other.

In addition, in the above embodiment, as an example of the electric wire accommodation device, the electric wire accommodation device 12 in which the plurality of electric wire reels 122 are accommodated and the plurality of electric wire gripping members 123 are attached such that each of the plurality of electric wire gripping members 123 corresponds to respective one of the plurality of electric wire reels 122 is exemplified. However, the electric wire accommodation device is not limited thereto, and one electric wire reel and one electric wire gripping member may be provided. However, as described above, it is possible to improve the degree of freedom in manufacturing the terminal-equipped electric wire W1 by providing the plurality of the electric wire reels 122 and the plurality of the electric wire gripping members 123. Even when a plurality of electric wire reels and a plurality of electric wire gripping members are provided, one or a plurality of spare electric wire reels from which the electric wire is not pulled out may be accommodated in the electric wire accommodation device in addition to the electric wire reels and the electric wire gripping members.

### REFERENCE SIGNS LIST

1 ELECTRIC WIRE PROCESSING APPARATUS
11 INFORMATION ACQUISITION UNIT
12 ELECTRIC WIRE ACCOMMODATION DEVICE
13 ELECTRIC WIRE SUPPLY DEVICE
14 B-SIDE TERMINAL SUPPLY PORTION
15 A-SIDE TERMINAL SUPPLY PORTION
16 BODY MECHANISM
16a CUT-OUT PORTION
16a-1 REEL-OUT MECHANISM
16a-2 CUTTING MECHANISM
17a A-SIDE RUBBER PLUG SUPPLY PORTION
17b B-SIDE RUBBER PLUG SUPPLY PORTION
121 ACCOMMODATION DEVICE BODY
121a ACCOMMODATION SHELF
121a-1, 121b-1 COLUMN MEMBER
121a-2 SHELF PLATE
121a-3 TOP PLATE
121b GUIDE SUPPORT PORTION
121b-2 VERTICAL RAIL
121b-3 HORIZONTAL RAIL
121b-4 OVERHANG PORTION
122 ELECTRIC WIRE REEL
123 ELECTRIC WIRE GRIPPING MEMBER
123a ATTACHMENT BASE PORTION
123a-1 PEDESTAL PORTION
123a-2 SCREWING THROUGH HOLE
123a-3 CENTRAL AXIS
123b PRE-GRIPPING PULLEY
123b-1 ROTATION PORTION
123c PLATE PORTION
123c-1 DELIVERY PORT
123d PAIR OF ROLLERS
123d-1 FIRST ROLLER
123d-2 SECOND ROLLER
123d-3 SHAFT
123e GRIPPING ARM
123f GRIPPING BIASING MEMBER
124 DRAWING MECHANISM
124a BASE PORTION
124b PIVOT ARM
124c DRAWING BIASING MEMBER
124d SPRING COUPLING PORTION
124e ROTATABLE PULLEY
124f FIXED PULLEY
161 A-SIDE CRIMPING MACHINE
162 A-SIDE RUBBER PLUG INSERTING MACHINE
163 A-SIDE ELECTRIC WIRE MOVING ARM
164 B-SIDE CRIMPING MACHINE
165 B-SIDE RUBBER PLUG INSERTING MACHINE
166 B-SIDE ELECTRIC WIRE MOVING ARM
D11 REEL-OUT DIRECTION
D12, D13 ARROW
D14 VERTICAL DIRECTION
D15 DRAWING DIRECTION
D16, D17 BIASING DIRECTION
D18 ADJUSTMENT ROTATION DIRECTION
T11 A-SIDE TERMINAL
T12 B-SIDE TERMINAL
TR1 TERMINAL REEL
TR11 CHAINED-TERMINALS BODY
TR11a TERMINAL
TR11b CARRIER
W1 ELECTRIC WIRE
W11 TERMINAL-EQUIPPED ELECTRIC WIRE
W111 SEGMENT ELECTRIC WIRE
Y OPERATOR

What is claimed is:

1. An electric wire accommodation device comprising:
an accommodation device body;
an electric wire reel being a reel around which an electric wire is wound and configured to be accommodated inside the accommodation device body, wherein the electric wire is configured to be pulled out to outside of the accommodation device body and to be intermittently reeled out by a reel-out mechanism provided outside the accommodation device body; and
an electric wire gripping member attached on a pull-out route in the accommodation device body along which the electric wire is pulled out and configured to grip the electric wire with a gripping force smaller than a reel-out force applied by the reel-out mechanism.

2. The electric wire accommodation device according to claim 1, wherein
the electric wire gripping member includes
a pair of rollers configured to sandwich the electric wire between circumferential surfaces of the pair of rollers, each of the pair of rollers being rotatable about an axis; and
a gripping biasing member configured to bias a first roller of the pair of rollers toward a second roller of the pair of rollers with a biasing force corresponding to the gripping force.

3. The electric wire accommodation device according to claim 1, wherein
the electric wire gripping member is provided with a delivery port configured to deliver the gripped electric wire and is attached to the accommodation device body such that an attachment posture of the electric wire gripping member is adjustable such that the delivery port is opened toward the reel-out mechanism.

4. The electric wire accommodation device according to claim 1, further comprising:
a drawing mechanism attached on the pull-out route in the accommodation device body at a position closer to the electric wire reel than the electric wire gripping member and configured to draw the electric wire in a drawing direction opposite to a reel-out direction by the reel-out mechanism and to allow the electric wire to pass therethrough.

5. The electric wire accommodation device according to claim 1, wherein
the accommodation device body includes an accommodation shelf in which a shelf plate is horizontally bridged between a plurality of column members each of which is provided upright along a vertical direction,
the electric wire reel is placed on the shelf plate such that a reel axis extends along the vertical direction,
the electric wire is pulled out upward, then changes a direction thereof to a horizontal side to extend horizontally, and then is pulled out to the outside of the accommodation device body, and
the electric wire gripping member grips a horizontally extending portion of the electric wire.

6. The electric wire accommodation device according to claim 5, wherein
the accommodation device body is provided with an overhang portion overhanging toward the reel-out mechanism at a position above the accommodation shelf,
the electric wire extends horizontally on the overhang portion and is pulled out to the outside of the accommodation device body, and
the electric wire gripping member is attached to a portion where the electric wire and an edge portion of the overhang portion on a side of the reel-out mechanism intersect with each other.

7. The electric wire accommodation device according to claim 1, wherein
a plurality of the electric wire reels is accommodated in the accommodation device body, and
a plurality of the electric wire gripping members is attached to the accommodation device body such that respective one of the plurality of electric wire gripping members corresponds respective one of the electric wire reels and grips the electric wire of respective one of the electric wire reels.

8. An electric wire processing apparatus comprising:
the electric wire accommodation device according to claim 1; and
a body mechanism including the reel-out mechanism and configured to reel out the electric wire by the reel-out mechanism and to cut a segment electric wire out of the electric wire, or to manufacture a terminal-equipped electric wire by crimping a terminal to at least one end of the segment electric wire.

9. The electric wire accommodation device according to claim 2, wherein
the electric wire gripping member is provided with a delivery port configured to deliver the gripped electric wire and is attached to the accommodation device body such that an attachment posture of the electric wire gripping member is adjustable such that the delivery port is opened toward the reel-out mechanism.

10. The electric wire accommodation device according to claim 9, further comprising:
a drawing mechanism attached on the pull-out route in the accommodation device body at a position closer to the electric wire reel than the electric wire gripping member and configured to draw the electric wire in a drawing direction opposite to a reel-out direction by the reel-out mechanism and to allow the electric wire to pass therethrough.

11. The electric wire accommodation device according to claim 10, wherein
the accommodation device body includes an accommodation shelf in which a shelf plate is horizontally bridged between a plurality of column members each of which is provided upright along a vertical direction,
the electric wire reel is placed on the shelf plate such that a reel axis extends along the vertical direction,
the electric wire is pulled out upward, then changes a direction thereof to a horizontal side to extend horizontally, and then is pulled out to the outside of the accommodation device body, and
the electric wire gripping member grips a horizontally extending portion of the electric wire.

12. The electric wire accommodation device according to claim 11, wherein
the accommodation device body is provided with an overhang portion overhanging toward the reel-out mechanism at a position above the accommodation shelf,
the electric wire extends horizontally on the overhang portion and is pulled out to the outside of the accommodation device body, and
the electric wire gripping member is attached to a portion where the electric wire and an edge portion of the overhang portion on a side of the reel-out mechanism intersect with each other.

13. The electric wire accommodation device according to claim 12, wherein
a plurality of the electric wire reels is accommodated in the accommodation device body, and
a plurality of the electric wire gripping members is attached to the accommodation device body such that respective one of the plurality of electric wire gripping members corresponds respective one of the electric wire reels and grips the electric wire of respective one of the electric wire reels.

14. An electric wire processing apparatus comprising:
the electric wire accommodation device according to claim 13; and
a body mechanism including the reel-out mechanism and configured to reel out the electric wire by the reel-out mechanism and to cut a segment electric wire out of the electric wire, or to manufacture a terminal-equipped electric wire by crimping a terminal to at least one end of the segment electric wire.
